(19) United States
(12) Patent Application Publication
(10) Pub. No.: US 2015/0337734 A1
(43) Pub. Date: Nov. 26, 2015

(54) Variable geometries fluid supply circuit and injection system supply circuit

(71) Applicant: Snecma, Paris (FR)

(72) Inventor: Sébastien Chalaud, Vincennes (FR)

(21) Appl. No.: 14/717,702

(22) Filed: May 20, 2015

(30) Foreign Application Priority Data
May 21, 2014 (FR) 14 54569

(51) Int. Cl. F02C 7/22

(52) U.S. Cl. CPC F02C 7/22

(57) ABSTRACT

The system for supplying fluid to a turbine machine comprises a low pressure pumping unit designed to increase the pressure in the fluid flowing towards the downstream circuit. The downstream circuit is subdivided at an inlet node into an injection system supply circuit and a variable geometries supply circuit. The variable geometries supply circuit is configured to carry fluid towards variable geometries from the inlet node to an outlet node connecting the variable geometries supply circuit to the upstream circuit. The injection system supply circuit comprises a high pressure volumetric pump and a pressure loss regulator configured to regulate pressure losses in the injection system supply circuit.

### TECHNICAL FIELD

The invention relates to the general technical field of fluid supply systems for turbine machines, particularly for the supply of lubricant or fuel. More precisely, the invention relates to a fluid supply system for a turbine machine combustion chamber and variable turbine machine geometries.

### STATE OF PRIOR ART

FIG. 1 shows a fuel supply system 10 for a turbine machine 1 according to one known state of the art design. The supply system 1 comprises a low pressure pump 11 configured to increase the fuel pressure flowing to a hydraulic resistance 104. The low pressure pump 11 is particularly a centrifugal pump. The fluid downstream from the low pressure pump 11 then flows towards a high pressure volumetric pump 102.

The high pressure volumetric pump 102 will supply fluid at constant flow to a supply circuit 50 for variable geometries 54 and to a fuel supply circuit 60 for a combustion chamber 2.

The supply circuit 50 for variable geometries 54 is designed to carry fuel from an inlet node E separating the supply circuit 50 for variable geometries 54 from the fuel supply circuit for the combustion chamber 2, as far as an outlet node C located between the low pressure pump 11 and the high pressure volumetric pump 102. This supply circuit 50 for variable geometries 54 is designed to supply a variable hydraulic power to the variable geometries 54.

The fuel supply circuit 60 to the combustion chamber 2 comprises a fuel metering valve 64 configured to regulate the fuel flow to the injection systems 62 of the combustion chamber 2. To achieve this, the fuel metering valve 64 is designed to allow excess fuel to pass through a fluid recirculation loop 610 from a first node A downstream from the inlet node E to the outlet node C.

However, this excess fuel circulating in the fluid recirculation loop 610 generates dissipation of a large amount of thermal energy in the supply system 10. More generally, the thermal power dissipated in the supply system 10 in FIG. 1 is high. The result is a reduction in the global performances of a turbine machine 1 comprising the supply system 10.

### PRESENTATION OF THE INVENTION

The invention is designed to at least partially solve problems encountered in solutions according to prior art.

To achieve this, the purpose of the invention is a system for supplying fluid to a turbine machine, the supply system including an upstream circuit and a downstream circuit connected to the upstream circuit.

The upstream circuit comprises a low pressure pumping unit designed to increase the pressure in the fluid flowing towards the downstream circuit.

The downstream circuit is subdivided at an inlet node into an injection system supply circuit for a combustion chamber and a variable geometries supply circuit.

The variable geometries supply circuit is configured to carry fluid transiting through variable geometries from the inlet node to an outlet node connecting the variable geometries supply circuit to the upstream circuit.

The injection system supply circuit comprises a high pressure volumetric pump.

According to the invention, the supply circuit of the injection system also includes a pressure loss regulator on the downstream side of the high pressure volumetric pump, the pressure loss regulator being configured to regulate pressure losses in the supply circuit as a function of the pressure difference between a high pressure inlet to the regulator through which the fluid in the supply circuit reaches the regulator downstream from the high pressure pump and a low pressure inlet to the regulator with fluid connection to a node in the supply circuit located on the upstream side of the high pressure volumetric pump.

The increase in the fluid pressure in the upstream circuit supplies the variable geometries supply circuit and also the injection system supply circuit, while fluid flow needs for the injection system and hydraulic pressure needs for the variable geometries are handled distinctly by a fluid supply regulation architecture. In particular, the variable geometries are not supplied with fluid through the high pressure volumetric pump. The total thermal power dissipated in the supply system is then reduced.

The pressure loss regulator is configured to maintain a pressure difference between the downstream side and the upstream side of the high pressure volumetric pump, sufficient to enable a higher pressure increase through the low pressure pumping unit without any risk of damaging the supply system. In particular, it limits the risk that the fluid pressure on the downstream side of the high pressure pump is less than the pressure on the upstream side of the high pressure pump.

Fluid in the supply system will be especially a lubricant, and particularly oil or fuel.

The invention may optionally comprise one or several of the following characteristics that may or may not be combined with each other.

Advantageously, the pressure loss regulator is configured to maintain a pressure difference between the downstream and upstream sides of the high pressure volumetric pump, higher than a strictly positive threshold. This threshold may be fixed or it may be variable.

The pressure loss regulator is preferably configured to maintain an approximately constant pressure difference between the upstream and downstream sides of the high pressure volumetric pump.

Preferably, the pressure loss regulator is designed such that fluid entering the regulator through the regulator high pressure inlet leaves the regulator through an outlet from it without it being possible for the fluid to be transferred to the upstream side of the high pressure volumetric pump through the regulator low pressure inlet.

The pressure loss regulator may comprise:

a mobile piston between at least one open position in which the piston allows fluid to circulate and an extreme closed position in which the piston prevents fluid circulation through the pressure loss regulator, and

a spring applying pressure to the piston to push it towards the closed position. As a variant, the spring may be replaced by another elastic means tending to bring/hold the piston towards an extreme closed position, particularly another return means.

Preferably, the piston partly delimits a chamber that communicates with the regulator low pressure inlet such that the fluid pressure in said chamber is approximately equal to the fluid pressure to said node in the supply circuit upstream from the high pressure volumetric pump.

Preferably, the fluid connection between the regulator low pressure inlet and the node in the supply circuit located on the upstream side of the high pressure volumetric pump is made through a conduit with an inside diameter less than the inside diameter of a conduit in the supply circuit leading to the regulator.

According to one advantageous embodiment, the low pressure pumping unit comprises a plurality of centrifugal pumps in series, and the outlet node is located between two pumps in the low pressure pumping unit. The low pressure pumping unit preferably comprises between two and five centrifugal pumps.

The plurality of centrifugal pumps that will further increase the pressure in the fluid that passes through them while limiting the dimension and dissipation of thermal energy in the low pressure pumping unit. The increase in power supplied by the low pressure pumping unit is not as high as the reduction in power supplied by the volumetric pump.

Advantageously, the high pressure pump is a geared volumetric pump configured to be mechanically driven by a turbine machine transmission box. The transmission box preferably transmits a torque transmitted through a high pressure shaft of the turbine machine to mechanically drive the high pressure volumetric pump. The high pressure volumetric pump is located particularly inside an Accessory Gear Box (AGB). The high pressure volumetric pump is then based on a robust and tested technology, for which limited development and certification efforts are necessary. As a variant, the high pressure volumetric pump may for example be an electric volumetric pump.

When the high pressure pump is a geared volumetric pump, the injection system supply circuit preferably comprises a fluid metering valve located on the downstream side of the high pressure pump and an injection system downstream from the fluid metering valve, the fluid metering valve being configured to regulate the flow towards the injection system and/or towards a fluid recirculation loop configured to carry fluid upstream from the high pressure pump. A fluid metering valve usually comprises a closing element with variable opening that may for example be in the form of a slide.

In particular, the fluid recirculation loop is configured to carry fluid from the metering valve to an evacuation node located between the low pressure pumping unit and the high pressure pump. The evacuation node for example connects the injection system supply circuit to the upstream circuit.

The evacuation node is as close as possible to the high pressure volumetric pump inlet in order to limit the thermal power dissipated in the fluid recirculation loop. Nevertheless, the evacuation node is usually located upstream from a hydraulic resistance, for example including a filter and/or a flow meter.

Preferably, the pressure loss regulator is located downstream from the fluid metering valve.

According to another advantageous embodiment, there are no volumetric pumps in the variable geometries supply circuit and the upstream circuit.

According to another special embodiment, the variable geometries supply circuit comprises a complementary pumping unit comprising one or several centrifugal pumps. As a variant, the variable geometries supply circuit does not have a pump. In this case, the pressure of the fluid supplying each variable geometry is generated as last resort by the low pressure pumping unit.

The invention also relates to a turbine machine comprising a fluid supply system like that defined above.

The invention also relates to a turbine machine comprising a differential reduction gear configured to drive at least one propeller in rotation and that will be supplied with lubricant through the supply system as defined above. The turbine machine may for example be a turbine machine with a set of counter rotating open propellers, also called Open Rotors.

### BRIEF DESCRIPTION OF THE DRAWINGS

This invention will be better understood after reading the following description of example embodiments given purely for information and in no way limitative with reference to the appended drawings, in which:

FIG. 1 is a partial diagrammatic view of a fuel supply system to an aircraft turbine machine according to one known state of the art design;

FIG. 2 is a partial diagrammatic view of a turbine machine fluid supply system according to one preferred embodiment of the invention;

FIG. 3 is a partial diagrammatic sectional view of the pressure loss regulator of the supply system in FIG. 2.

### DETAILED PRESENTATION OF PARTICULAR EMBODIMENTS

Identical, similar or equivalent parts in the different figures have the same numeric references to facilitate comparison between the different figures.

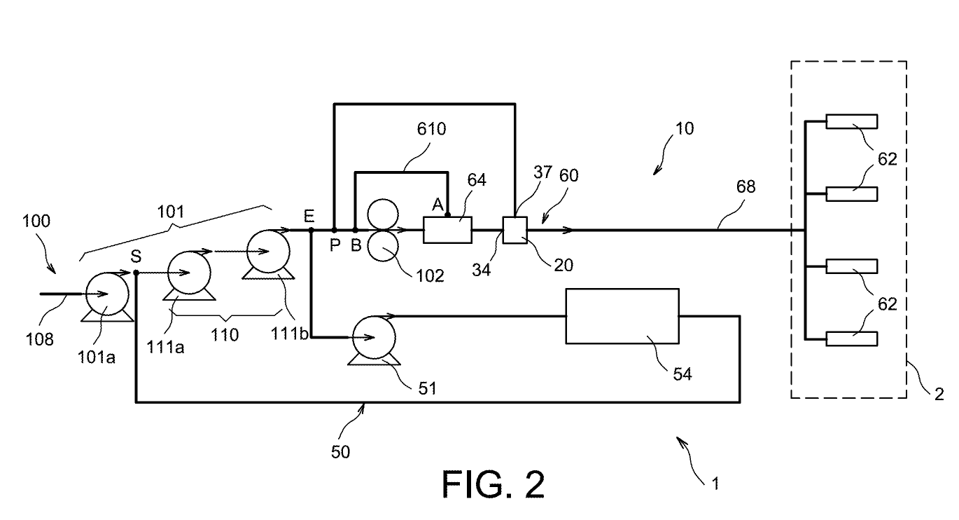

FIG. 2 shows a system 10 for the supply of fluid to an aircraft turbine machine 1. In the embodiment disclosed, the fluid is fuel. Nevertheless, when the turbine machine 1 comprises a differential reduction gear (not shown) configured to drive at least one propeller in rotation, the fluid may also be a lubricant and typically oil.

The turbine machine 1 comprises the supply system 10, one or several variable geometries 54 and a combustion chamber 2. These variable geometries 54 consist of turbine machine equipment 1 for which hydraulic power has to be drawn off for it to operate. The variable geometries 54 may have variable natures, for example they may include an actuator, a servovalve, a compressor variable discharge valve, a compressor transient discharge valve and/or an air flow regulation valve for a system to vary the clearance at the tips of rotor blades for a low pressure turbine or a high pressure turbine.

The combustion chamber 2 is supplied with fuel through a plurality of fuel injectors cooperating with the corresponding fuel injection systems 62.

The supply system 10 comprises an upstream circuit 100 and a downstream circuit 50, 60. The downstream circuit 50, 60 is connected to the upstream circuit 100 and is located downstream from the upstream circuit 100. The terms “upstream” and “downstream” are defined with reference to the general fuel flow direction in the supply system 10 towards the combustion chamber 2.

The upstream circuit 100 comprises a low pressure pumping unit 101, also called the low pressure pumping module, increasing the pressure in the fuel flowing towards the downstream circuit 50, 60. The low pressure pumping unit 101 increases the fuel pressure so as to limit/prevent cavitation risks inside a high pressure pump 102 that outputs a constant fuel flow depending on the engine rotation speed. In the embodiment described, the high pressure pump 102 is a geared volumetric pump mechanically driven in rotation through a transmission box of the turbine machine 1.

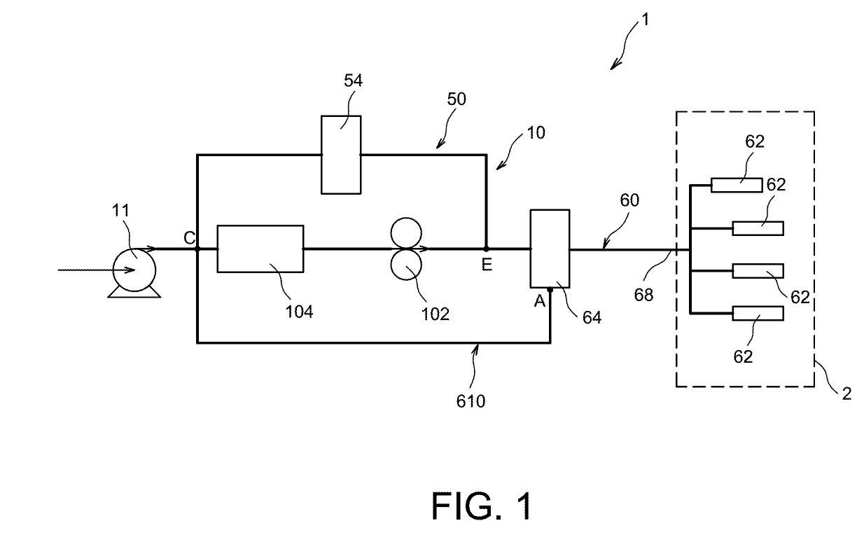

The upstream circuit 100 may comprise a hydraulic resistance 104 like that shown in FIG. 1, between the low pressure pumping unit 101 and the downstream circuit 50,60 or between two stages of the low pressure pumping unit 101. In this document, the term “hydraulic resistance” is used to define the magnitude derived from the ratio between the difference in fluid pressure between the input and the output of an element of the supply system, and the fluid flow passing through the element (by analogy with electricity). By metonymy and still by analogy with electricity, the term “hydraulic resistance” is also used to denote an element of the supply system characterised by this magnitude. For example, the hydraulic resistance 104 of the upstream circuit 100 comprises an exchanger, a fuel filter, a cut-off valve and/or a flow meter.

The downstream circuit 50, 60 comprises a supply circuit 60 to injection systems 62 for a combustion chamber 2, and a variable geometries supply circuit 50. The variable geometries supply circuit 50 and the supply circuit 60 to injection systems 62 are separated at an inlet node E located downstream from the low pressure pumping unit 101.

The supply circuit 60 to injection systems comprises a discharge valve and a fuel metering valve represented by the module 64 and that are configured to regulate the flow to the injection system 62. The discharge valve and the fuel metering valve 64 direct excess fuel in the supply circuit 60 to the injection systems 62 to the upstream circuit 100 through a fuel recirculation loop 610. The recirculation loop 610 is located between a first node A downstream from the inlet node E and an evacuation node B located downstream from the low pressure pumping unit 101. The evacuation node B is located between the low pressure pumping unit 101 and the high pressure volumetric pump 102. The injection system supply circuit 60 between the fuel metering valve 64 and the injection systems 62 comprises a fuel inlet conduit 68.

The variable geometries supply circuit 50 is configured to carry fluid transiting through the variable geometries 54 from the inlet node E as far as an outlet node S connecting the variable geometries supply circuit 50 to the upstream circuit 100.

The supply system 10 in FIG. 2 is different from the system in FIG. 1 mainly in that the upstream circuit 100 does not have a high pressure volumetric pump 102, in that the low pressure pumping unit 101 is composed of a plurality of centrifugal pumps 101a, 111a, 111b, and in that the injection system supply circuit 60 comprises a pressure loss regulator 20.

The low pressure pumping unit 101 in FIG. 2 further increases the fluid pressure towards the high pressure pump 102 so that it is higher than pressure at the low pressure centrifugal pump 11 in FIG. 1. The high pressure volumetric pump 102 in FIG. 2 then creates a correspondingly lower increase in fluid pressure. The fuel flow circulating in the recirculation loop 610 is also lower in the configuration shown in FIG. 2. The result is a global reduction in thermal losses in the supply system 10.

Moving the high pressure volumetric pump 102 from the upstream circuit 100 to the supply circuit 60 to injection systems 62 enables to reduce the fuel flow output by the volumetric pump 102. Global thermal losses in the supply system 10 are even lower.

The pressure loss regulator 20 is located downstream from the high pressure pump 102. This makes it possible for the pressure downstream from the high pressure pump 102 to be sufficiently higher than the pressure upstream from the high pressure pump 102. The low pressure pumping unit 101 can thus further increase the pressure in the fluid passing through it, which can further reduce the work done by the high pressure pump 102 at least during some flight phases. The result is an even greater reduction in thermal losses in the supply system 10.

The pressure loss regulator 20 maintains a pressure difference between the downstream limit and the upstream limit of the high pressure volumetric pump 102 greater than a strictly positive threshold S₀. For example, the threshold S₀ may be of the order of 4 bars. The pressure loss regulator 20 in particular maintains an approximately constant pressure difference at the limits of the high pressure volumetric pump 102, possibly except for transient conditions in which the pressure loss regulator is not in mechanical and/or electrical equilibrium. The pressure loss regulator 20 regulates the pressure loss in the supply circuit 60 to the injection systems as a function of the pressure difference between a first low pressure input called the LP inlet 37 located upstream from the volumetric pump 102 to which it is connected through node P, possibly upstream from the evacuation node B, and a second high pressure inlet in this case called the HP inlet 34 located on the downstream side of the metering valve 64.

The fluid connection between the low pressure inlet 37 and node P is made by a conduit with an inside diameter less than the inside diameter of a conduit in the supply circuit leading to regulator 20. The piston 32 participates in delimiting a chamber that communicates with the low pressure inlet 37 such that the fluid pressure in this chamber is approximately equal to the fluid pressure at node P. In other words, the low pressure inlet 37 will be used to tap the pressure on the upstream side of the high pressure pump 102 rather than to carry fuel to the upstream side of the high pressure pump 102.

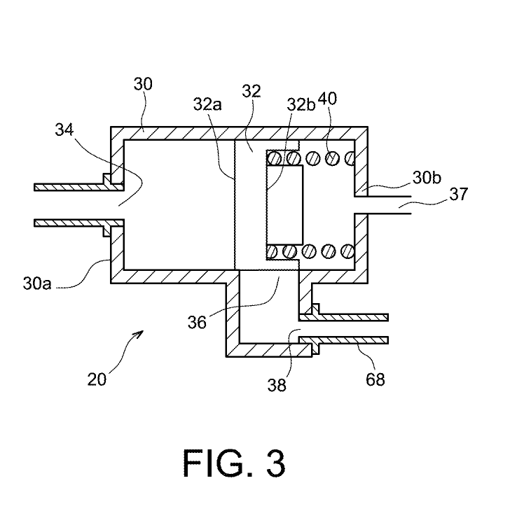

With reference to FIG. 3, fluid entering the regulator through the high pressure inlet 34 leaves the regulator through an outlet 38 without it being possible to transfer it upstream from the high pressure volumetric pump 102 through the low pressure inlet 37.

The pressure loss regulator 20 is in the form of a valve in which the closing element with variable opening is a piston 32. The piston 32 is free to move between an extreme open position in which the piston 32 does not limit fluid circulation, and an extreme closed position in which the piston 32 prevents all fluid circulation through the pressure regulator 20. The piston 32 may also be in equilibrium between these two extreme positions.

It is mounted free to move along the axial direction in a cylinder 30. The position of the piston 32 determines the passage cross-section through a slot 36 formed in the side wall of the cylinder 30 and connected to the conduit 68 through the outlet 38. The piston 32 has a front face 32a facing the end wall 30a of the cylinder in which the opening to the HP inlet 34 is formed, and a back face 32b against which a spring 40 applies an elastic return force. The spring 40 is located between the piston 32 and the end wall 30b of the cylinder opposite the wall 30a.

When the difference between the pressure at the HP inlet 34 and the pressure at the outlet 38 increases, the piston 32 moves in resistance to the return force of the spring 40 which increases the cross-sectional passage in the slot 38 and reduces the pressure loss. Conversely, when the difference between the pressure at the HP inlet 34 and the pressure at the LP outlet 38 reduces, the piston 32 is pushed back by the spring 40, which reduces the cross-sectional passage through the slot 36 and increases the pressure loss. The value of the pressure loss is determined by the return force of the spring 40. By modifying the return force, the threshold S₀ can be varied and adapted to the needs of the supply system 10.

The low pressure pumping unit 101 in FIG. 2 comprises a plurality of centrifugal pumps 101a, 111a, 111b. In this respect, note that it would not have been fully satisfactory to simply replace the low pressure pump 11 in FIG. 1 by a low pressure pump 11 with a higher capacity. The pressure difference at the limits of a centrifugal pump is proportional to the square of the radius of the pump. More importantly, the energy efficiency of a centrifugal pump reduces with the cube of the radius of this pump. Replacing the low pressure pump 11 in FIG. 1 by a larger radius centrifugal low pressure pump and therefore with a higher capacity configured to increase the fluid pressure passing through it even further, would have reduced the energy efficiency and therefore considerably increased thermal losses. Therefore this solution would not have produced such important advantages as the solution shown in FIG. 2 in terms of the global thermal balance of the supply system 10.

Furthermore, the increase in pressure supplied through the low pressure pumping unit 101 in FIG. 2 in comparison with the supply system 10 in FIG. 1 is particularly advantageous if the hydraulic pressure needs of the variable geometries supply circuit 50 are identical to the needs of the supply system 10 in FIG. 1. The variable geometries supply circuit 50 may include a complementary pumping unit 51. This assembly 51 may for example be composed of one or several centrifugal pumps. The complementary pumping unit 51 can eliminate any pressure reduction resulting from elimination of the volumetric pump 102 in the upstream circuit 100 and that would not be fully compensated by the plurality of centrifugal pumps 101a, 111a et 111b. The complementary pumping unit 51 can satisfy a need for a large isolated flow through the variable geometries 54, for example during displacement of the hydraulic actuator.

The outlet node S of the supply system 10 in FIG. 2 is located between two pumps 101a, 111a in the low pressure pumping unit 101, so as to maintain a sufficient pressure difference between the downstream side of the complementary pumping unit 51 and the outlet node S, while limiting the dissipation of thermal energy in the supply system 10. The supply system 10 in FIG. 2 is configured particularly such that the pressure difference between the downstream side of the complementary pumping unit 51 and the outlet node S from the supply system in these figures is approximately identical to that in FIG. 1, during operation of the supply system 10.

More precisely and with reference to the embodiment shown in FIG. 2, the low pressure pumping unit 101 is composed of three centrifugal pumps 101a, 111a, 111b mounted in series. Furthermore, the outlet node S is located between an upstream pumping unit 101a comprising a centrifugal pump and a downstream pumping unit 110 comprising two centrifugal pumps 111a, 111b.

In general, the upstream pumping unit 101a may comprise several centrifugal pumps and the number of centrifugal pumps in the downstream pumping unit 110 can vary depending on hydraulic power and fluid flow needs of the turbine machine 1. Similarly, the pumps in the low pressure pumping unit 101 are not necessarily identical.

Obviously, those skilled in the art can make various modifications to the invention that has just been disclosed, without going outside the scope of the invention as disclosed above.

1. System for supplying fluid to a turbine machine, the supply system including an upstream circuit and a downstream circuit connected to the upstream circuit,
the upstream circuit comprising a low pressure pumping unit designed to increase the pressure in the fluid flowing towards the downstream circuit,
the downstream circuit being subdivided at an inlet node into an injection system supply circuit for a combustion chamber and a variable geometries supply circuit,
in which the variable geometries supply circuit is configured to carry fluid transiting through variable geometries from the inlet node to an outlet node connecting the variable geometries supply circuit to the upstream circuit,
in which the injection system supply circuit comprises a high pressure volumetric pump and a pressure loss regulator installed on the downstream side of the high pressure volumetric pump,
in which the pressure loss regulator is configured to regulate pressure losses in the supply circuit as a function of the pressure difference between a high pressure inlet of the regulator through which the fluid in the supply circuit reaches the regulator downstream from the high pressure pump and a low pressure inlet of the regulator with fluid connection to a node in the supply circuit located on the upstream side of the high pressure volumetric pump.

2. Supply system according to claim 1, in which the pressure loss regulator is configured to maintain a pressure difference between the downstream side and the upstream side of the high pressure volumetric pump higher than a strictly positive threshold.

3. Supply system according to claim 2, in which the pressure loss regulator is designed to maintain an approximately constant pressure difference between the upstream and downstream sides of the high pressure volumetric pump.

4. Supply system according to claim 1, in which the pressure loss regulator is designed such that fluid entering the regulator through the regulator high pressure inlet leaves the regulator through an outlet from it without it being possible for the fluid to be transferred to the upstream side of the high pressure volumetric pump through the regulator low pressure inlet.

5. Supply system according to claim 1, in which the pressure loss regulator comprises:
a mobile piston mobile between at least one open position in which the piston allows fluid to circulate and an extreme closed position in which the piston prevents fluid circulation through the pressure loss regulator, and
a spring applying pressure to the piston to push it towards the closed position.

6. Supply system according to claim 5, in which the piston partly delimits a chamber that communicates with the regulator low pressure inlet such that the fluid pressure in said chamber is approximately equal to the fluid pressure to said node in the supply circuit upstream from the high pressure volumetric pump.

7. Supply system according to claim 1, in which the fluid connection between the regulator low pressure inlet and the node in the supply circuit located on the upstream side of the high pressure volumetric pump is made through a conduit with an inside diameter less than the inside diameter of a conduit in the supply circuit leading to the regulator.

8. Supply system according to claim 1, in which the low pressure pumping unit comprises a plurality of centrifugal pumps in series, and the outlet node is located between two pumps in the low pressure pumping unit.

9. Supply system according to claim 1, in which the high pressure pump is a geared volumetric pump configured to be mechanically driven by a turbine machine transmission box.

10. Supply system according to claim 1, in which the injection system supply circuit preferably comprises a fluid metering valve located on the downstream side of the high pressure pump and an injection system downstream from the fluid metering valve, the fluid metering valve being configured to regulate the flow towards the injection system and/or towards a fluid recirculation loop configured to carry fluid upstream from the high pressure pump.

11. Supply system according to claim 10, in which the pressure loss regulator is located downstream from the fluid metering valve.

12. Supply system according to claim 1, in which there are no volumetric pumps in the variable geometries supply circuit and the upstream circuit.

13. Supply system according to claim 1, in which the variable geometries supply circuit comprises a complementary pumping unit comprising one or several centrifugal pumps.

14. Turbine machine comprising a fluid supply system, according to claim 1.
